(19) United States
(12) Patent Application Publication
(10) Pub. No.: US 2022/0027419 A1
(43) Pub. Date: Jan. 27, 2022

(54) SMART SEARCH AND RECOMMENDATION METHOD FOR CONTENT, STORAGE MEDIUM, AND TERMINAL

(71) Applicant: SHENZHEN SEKORM COMPONENT NETWORK CO., LTD, Shenzhen, Guangdong (CN)

(72) Inventor: Meie LIU, Shenzhen, Guangdong (CN)

(21) Appl. No.: 17/413,106

(22) PCT Filed: Dec. 28, 2018
(86) PCT No.: PCT/CN2018/124783

§ 371 Date: Jun. 11, 2021

(51) Int. Cl. G06F 16/903; G06K 9/00; G06F 16/906; G06F 16/9032

(52) U.S. Cl. CPC G06F 16/90344; G06F 16/90324; G06F 16/906; G06K 9/00483

(57) ABSTRACT

The invention relates to a smart search and recommendation method for content, a storage medium and a terminal. The method comprise: matching a document title with keywords extracted from the document content, and combining the matched keywords into a core keyword according to the matching sequence of words in the document title; storing a core keyword and the correlation between the core keyword and the document; receiving a search keyword and searching a search result corresponding to the search keyword; according to the page structure of the display page, selecting part of the search results to display; and hiding and displaying the unselected search results, and as information require for search engine optimization. The proposal is a recommendation idea of a multiplexing search logic, so the invention has the advantages of low development cost, high reusability, flexibility and easy expansion.

### BACKGROUND OF THE INVENTION

### 1. Technical Field

The invention relates to the field of electronic component search, in particular to a smart search and recommendation method for content, a storage medium and a terminal.

### 2. Description of Related Art

In the search field of electronic components and electronic component supporting materials, the prior art adopts manual extraction of core points or core points according to the frequency of captured words in the database establishment stage, and the manual extraction of core points leads to high cost and low efficiency, and cannot meet the processing requirements of a large amount of data. However, extracting the core points according to the frequency of capturing words can only reflect the number of times the words appear in the document, but cannot know whether it is the core meaning of the document from the meaning, which leads to inaccurate search results in the later period.

### BRIEF SUMMARY OF THE INVENTION

The technical problem to be solved by the present invention is to provide a smart search and recommendation method for content, a storage medium and a terminal aiming at the defects of the prior art.

The technical proposal adopted by the invention to solve the technical problem is to construct a smart search and recommendation method for content, which comprises the following steps:

matching the document title with the document content and four types of key words of model, commodity classification, brand, and market application extracted from the content to obtain a core keyword extracted from the content;

storing the core keyword and the correlation between the core keyword and the document;

receiving a search keyword and searching a search result corresponding to the search keyword;

and displaying the search result.

Further, in the smart search and recommendation method for content of the present invention, the matching of the document title with the document content and the four types of keywords of model, commodity classification, brand, and market application extracted from the content to obtain the core keyword comprises:

matching the document title with four types of keywords of model, commodity classification, brand and market application extracted from the document content, and combining the matched keyword into the core keyword according to the matching sequence of the words in the document title.

Further, in the smart search and recommendation method for content according to the present invention, after matching the document title with the document content and the four types of keywords of model, commodity classification, brand, and market application extracted from the content, the method further comprises:

if the document title is not matched with the document content, selecting a keyword extracted from the document content as the core keyword.

Further, in the smart search and recommendation method for content of the present invention, the selecting of a keyword extracted from the document content as the core keyword comprises:

if there is a model keyword in the document content, selecting the model keyword as the core keyword;

if there is no model keyword in the document content, selecting a commodity classification keyword in the document content as the core keyword;

and if there is no commodity classification keyword in the document content, selecting a brand keyword in the document content as the core keyword.

Further, in the smart search and recommendation method for content of the present invention, the selecting of the model keyword as the core keyword comprises: selecting a first model keyword in the document content as the core keyword;

the selecting a commodity classification keyword in the document content as a core keyword comprises: selecting a first commodity classification keyword in the document content as the core keyword;

the selecting of a brand keyword in the document content as the core keyword comprises: selecting a first brand keyword in the document content as the core keyword.

Further, in the smart search and recommendation method for content of the present invention, the searching a search result corresponding to the search keyword comprises:

searching a core keyword matched with the search keyword;

and obtaining the document corresponding to the search keyword according to the correlation between the core keyword and the document.

Further, in the smart search and recommendation method for content according to the present invention, the displaying the search result comprises:

selecting part of the search result to display according to the page structure of the display page; and hiding and displaying the unselected search results as the information required by the search engine optimization.

Further, in the smart search and recommendation method for content according to the present invention, the searching a search result corresponding to the search keyword comprises: searching a search result corresponding to the search keyword and the resource and service information related to the content of the search result;

and display the search result and resource and service information related to the content in the search result.

In addition, the present invention also provides a computer-readable storage medium having stored thereon a computer program which, when executed by a processor, implements the smart search and recommendation method for content as described above.

In addition, the invention also provides a terminal which comprises a processor, wherein the processor is used for realizing the steps of the smart search and recommendation method for the content when executing the computer program stored in the memory.

The smart search and recommendation method for content, the storage medium and the terminal have the following beneficial effects: that the method comprises the following steps: matching keywords extracted from document title and document content, wherein the matched keyword are combined into core keyword according to the matching sequence of the words in the document title; storing a core keyword and the correlation between the core keyword and the document; receiving a search keyword and searching a search result corresponding to the search keyword; according to the page structure of the display page, selecting part of the search results to display; the unselected search results are hidden and displayed, and are used as information required by search engine optimization. The invention is suitable for the content recommendation service in the vertical field, opens the service closed loop in the vertical field for a single content, and has the advantages of low development cost, high reusability, flexibility and easy expansion because the proposal is a recommendation idea of multiplexing search logic, plus the recommended display contains dominant display and recessive display, so in the amount of information displayed more abundant, both does not affect the user experience is also conducive to search engine SEO.

### BRIEF DESCRIPTION OF THE SEVERAL VIEWS OF THE DRAWINGS

Brief description of that drawing the invention will now be further described by way of example with reference to the accompany drawings in which:

FIG. 1 is a flowchart of a smart search and recommendation method for content according to an embodiment of the present invention;

FIG. 2 is a flowchart of a smart search and recommendation method for content according to an embodiment of the present invention;

FIG. 3 is a flowchart of obtaining core keywords in a method provided by an embodiment of the present invention;

FIG. 4 is a schematic structural diagram of a terminal according to an embodiment of the present invention.

### DETAILED DESCRIPTION OF THE INVENTION

For a clearer understanding of the technical features, objects and effects of the present invention, a detailed description will now be given of specific embodiments of the present invention with reference to the accompanying drawings.

### Example

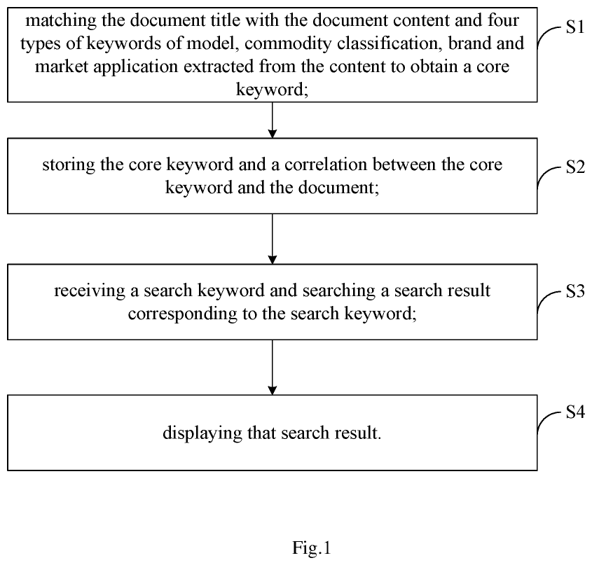

As shown in FIG. 1, the smart search and recommendation method for content of this embodiment is applied to search the content of a document, which includes a document title and document content. Documents include, but are not limited to, parameter documents of electronic components, usage instruction documents of electronic components, technical question and answer documents, mails, and the like, and any document containing a title belongs to the document of the present embodiment. Preferably, the documents are all electronic component related documents. Specifically, the method comprises the following steps:

S1, matching the document title with the document content and four types of keywords extracted from the content, namely, model, commodity classification, brand and market application to obtain a core keyword. Firstly, the title of the document is divided into multiple words according to the word segmentation template, and each word is matched with the content of the document, and the word matched with the content of the document is used as a core keyword. Further, the words in the title of the document matched with the content of the document have a certain matching order in the title of the document, and there is a certain order in the words of the title, then the words are matched with four types of keywords, namely model, commodity classification, brand, and market application, extracted from the content and the content of the documents to obtain core keywords, which include: matching the document title with the document content and the keywords extracted from four categories of keywords: model, commodity classification, brand and market application, the matched keywords are combined into the core keywords according to the matching order of the words in the title of the document.

S2, storing the core keyword and the correlation between the core keyword and the document. After the core keywords are obtained by matching, the correlation between the core keywords and the documents is established, and the correlation between the core keywords and the documents is stored to establish a database. Each piece of data takes the core keyword as the search tag, that is, it is searched by judging whether it matches the core keyword.

S3, receiving a search keyword, and searching for a search result corresponding to the search keyword. Alternatively, the search keyword may be received by an input device, or received and recognized by a voice receiving device, or received by a camera scanning a bar code or a two-dimensional code of an electronic component. Further, searching for the search result corresponding to the search keyword comprises:

searching a core keyword matched with the search keyword; after receiving the search keyword, judging whether the search keyword is matched with the core keyword in the database or not, and if the search keyword is matched, taking the document corresponding to the core keyword as a search result.

And obtaining the documents corresponding to the search keywords according to the correlation between the core keywords and the documents.

S4, displaying that search results. By including multiple related documents in the search results, but limited to the display capacity of the display interface, it is impossible to display all search results at the same time, so it is necessary to select part of the search results for recommended display according to the page structure of the display page; for example, there are ten related documents in the search results, but the display interface displays up to five related documents at a time. Unselected search results for hidden display, although the user cannot see, but can be used as search engine optimization (SEO) required information, such as an article hidden in the display of A model electronic components, users in the Baidu search engine search A model electronic components, when users search for A model electronic components on Baidu search engine, Baidu search engine will recommend this article to users, and the displayed part will take the contents ranked first in the search results.

Further, searching for the search result corresponding to the search keyword in the method for recommending smart search for content in this embodiment includes searching for the search result corresponding to the search keyword and the resource and service information related to the content of the search result, and since the search results already contain the search keyword, the search results also contain the associated information related to the search keyword. According to the correlation information, the electronic component service platform is searched, the resource and service information corresponding to the related information is obtained, and the resource and service information is also used as a search result corresponding to the search keyword, so that the content of the search result is enriched, and more services are provided for a user. For example, when a user searches for an electronic component of a certain model, the search result can show the user other model resources and services under the brand corresponding to the model or the resources and services corresponding to the electronic component of the same functional model besides the resources and services related to the electronic component itself of the model. Correspondingly, displaying the search result in the smart search and recommendation method for the content comprises displaying the search result and resource and service information related to the content in the search result.

Alternatively, only that summary information of each document in the search result can be displayed when displaying the search result and resource and service information related to the content in the search result, so that more document can be displayed on the same display page, and the user can conveniently and quickly view the documents. After that user select a document to view, the selected document is opened.

According to the embodiment, the past core keyword is matched with the document title and the document content, so that the core keyword can reflect the core content of the document, the construction cost of a search database is reduced, and the accuracy and richness of a search result are improved.

### Example

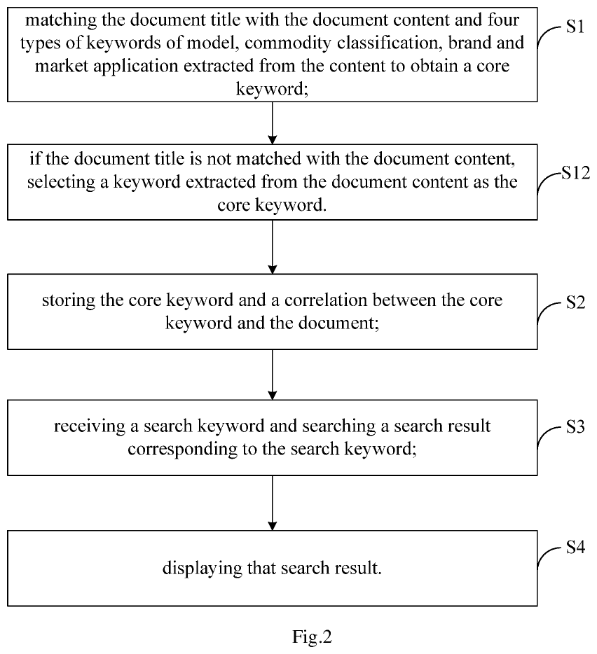

As shown in FIG. 2, on the basis of the above embodiment, the smart search and recommendation method for content in this embodiment, after matching the document title with the document content and four types of keywords extracted from the content, such as model, commodity classification, brand and market application, further comprises:

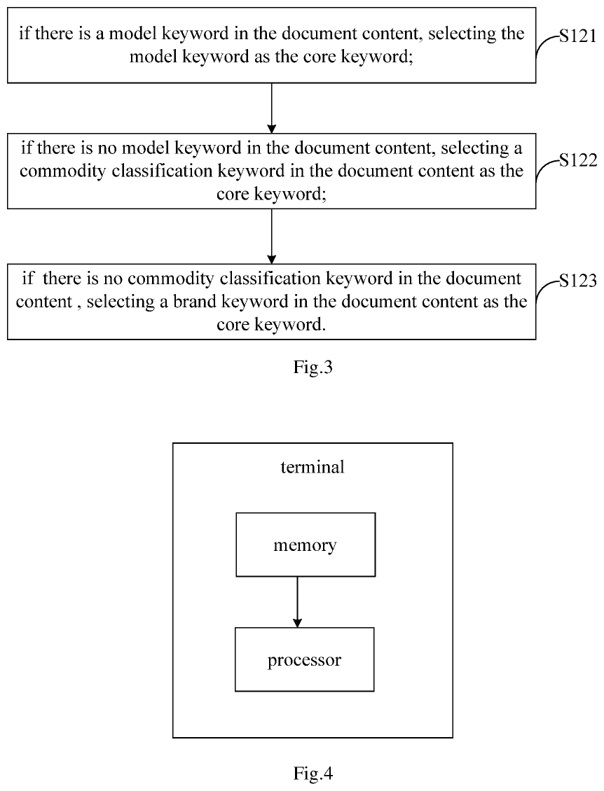

S12. If the document title does not match the document content, the extracted keyword from the document content is selected as the core keyword. The keywords extracted from the content of the document can be selected according to the occurrence frequency of the keywords, the relevance between the keywords and the title of the document, and the types of the keywords, wherein the types of the keywords include but are not limited to model keywords, commodity classification keywords, brand keywords, market application keywords and the like. As shown in FIG. 3, selecting the keywords extracted from the document content as the core keywords comprises:

S121. if there is a model keyword in the document content, selecting the model keyword as a core keyword;

S122, if there is no model keyword in the document content, selecting a commodity classification keyword in the document content as a core keyword;

S123. if there is no commodity classification keyword in the document content, selecting a brand keyword in the document content as a core keyword.

Further, the smart search and recommendation method for content in this embodiment, selecting the model keyword as the core keyword comprises: selecting a first model keyword in the document content as the core keyword;

selecting a commodity classification keyword in the document content as a core keyword comprises: selecting a first commodity classification keyword in the document content as the core keyword;

selecting a brand keyword in the document content as a core keyword comprises: selecting a first brand keyword in the document content as the core keyword.

In the embodiment, the document title and the document content are matched with the past core keyword, and if the document title is not matched with the document content, the extracted keyword in the document content is selected as the core keyword; thereby ensuring that the core keywords can reflect the core content of the document, reducing the construction cost of a search database, and improving the accuracy and the richness of search results.

In some embodiments, the smart search and recommendation method for content is applied to an electronic component selling website, and the electronic component selling website can be operated in a smart phone, a tablet computer, a notebook computer or a desktop computer, and can be accessed in the form of a website or in the form of an application program. Documents include, but are not limited to, parameter documents of electronic components, usage instruction documents of electronic components, technical question and answer documents, mails, and the like.

### Example

This embodiment provides a computer-readable storage medium having stored thereon a computer program that, when executed by a processor, implements the smart search and recommendation method for content as described above.

### Example

As shown in FIG. 4, this embodiment provides a terminal, which includes a processor, and the processor is configured to implement the steps of the smart search and recommendation method for content when executing the computer program stored in the memory. Alternatively, terminals include, but are not limited to, smart phones, tablet computers, notebook computers, desktop computers, servers, and the like.

According to the embodiment, the past core keywords are matched with the document title and the document content, so that the core keywords can reflect the core content of the document, the construction cost of a search database is reduced, and the accuracy and richness of a search result are improved.

The embodiments are described in this specification in a progressive manner, with emphasis being placed on the differences between each embodiment and the other embodiments, and with reference to like parts of the embodiments. As for the device disclosed in the embodiment, since it corresponds to the method disclosed in the embodiment, the description is relatively simple, and the description of the related part can be referred to the method part.

Those skilled in the art will further appreciate that the example elements and algorithm steps described in connection with the embodiments disclosed herein can be implemented as electronic hardware, computer software, or a combination of both, and that the example components and steps have been described generally functionally throughout the foregoing description in order to clearly illustrate the interchangeability of hardware and software. Whether these functions are performed in hardware or software depends on the particular application and design constraints of the technical solution. Killed artisans may implement the described functionality using different approaches for each particular application, but such implementations should not be construed as beyond the scope of the present invention.

The steps of a method or algorithm described in connection with the embodiments disclosed herein may be embodied directly in hardware, in a software module executed by a processor, or in a combination of the two. A software module may reside in random access memory (RAM), memory, read only memory (ROM), electrically programmable ROM, electrically erasable programmable ROM, registers, hard disk, a removable disk, a CD-ROM, or any other form of storage medium known in the art.

The above embodiments are only for illustrating the technical concepts and feature of the present invention, and are intended to enable those skilled in the art to understand and implement the present invention, but not to limit the scope of protection of the present invention. All equivalent change and modifications that come within that scope of the append claims are intended to be embraced therein.

What is claimed is:

1. A smart search and recommendation method for content, comprising:
matching the document title with the document content and four types of keywords of model, commodity classification, brand and market application extracted from the content to obtain a core keyword;
storing the core keyword and a correlation between the core keyword and the document;
receiving a search keyword and searching a search result corresponding to the search keyword;
and displaying that search result.

2. The smart search and recommendation method for content according to claim 1, wherein the step of matching the document title with the document content and the four types of keywords of model, commodity classification, brand, and market application extracted from the content to obtain a core keyword comprises:
matching the document title with the document content and four types of keyword of model, commodity classification, brand and market application extracted from the content, and combining the matched keyword into the core keyword according to the matching sequence of words in the document title.

3. The smart search and recommendation method for content according to claim 1, wherein after the matching of the document title with the document content and the four types of keywords of model, commodity classification, brand, and market application extracted from the content, the method further comprises:
if the document title is not matched with the document content, selecting a keyword extracted from the document content as the core keyword.

4. The smart search and recommendation method for content according to claim 3, wherein the selecting a keyword extracted from the document content as the core keyword comprises:
if there is a model keyword in the document content, selecting the model keyword as the core keyword;
if there is no model keyword in the document content, selecting a commodity classification keyword in the document content as the core keyword;
and if there is no commodity classification keyword in the document content, selecting a brand keyword in the document content as the core keyword.

5. The smart search and recommendation method for content according to claim 4, wherein the selecting the model keyword as the core keyword comprises: selecting a first model keyword in the document content as the core keyword;
selecting a commodity classification keyword in the document content as a core keyword comprises: selecting a first commodity classification keyword of the document content as the core keyword;
selecting a brand keyword in the document content as the core keyword comprises: selecting a first brand keyword of the document content as the core keyword.

6. The smart search and recommendation method for content according to claim 1, wherein the searching a search result corresponding to the search keyword comprises:
searching a core keyword matched with the search keyword;
and obtaining the document corresponding to the search keyword according to the correlation between the core keyword and the document.

7. The smart search and recommendation method for content according to claim 1, wherein the displaying the search result comprises:
selecting part of the search result to display according to the page structure of the display page; and hiding and displaying the unselected search results as the information required by the search engine optimization.

8. The smart search and recommendation method for content according to claim 1, wherein the searching a search result corresponding to the search keyword comprises: searching for the search result corresponding to the search keyword, and resource and service information related to the content of the search result;
and displaying that search result comprising: displaying the search result, and resource and service information related to the content in the search result.

9. A computer-readable storage medium having a computer program stored thereon, wherein the computer program, when executed by a processor, implements the smart search and recommendation method for content according to claim 1.

10. A terminal comprising a processor for implementing the steps of the smart search and recommendation method for content according to claim 1 when executing a computer program stored in a memory.

11. The computer-readable storage medium according to claim 9, wherein the step of matching the document title with the document content and the four types of keywords of model, commodity classification, brand, and market application extracted from the content to obtain a core keyword comprises:
matching the document title with the document content and four types of keyword of model, commodity classification, brand and market application extracted from the content, and combining the matched keyword into the core keyword according to the matching sequence of words in the document title.

12. The computer-readable storage medium according to claim 9, wherein after the matching of the document title with the document content and the four types of keywords of model, commodity classification, brand, and market application extracted from the content, the method further comprises:
if the document title is not matched with the document content, selecting a keyword extracted from the document content as the core keyword.

13. The computer-readable storage medium according to claim 9, wherein the displaying the search result comprises:
selecting part of the search result to display according to the page structure of the display page; and hiding and displaying the unselected search results as the information required by the search engine optimization.

14. The computer-readable storage medium according to claim 9, wherein the displaying the search result comprises:
selecting part of the search result to display according to the page structure of the display page; and hiding and displaying the unselected search results as the information required by the search engine optimization.

15. The computer-readable storage medium according to claim 9, wherein the searching a search result corresponding to the search keyword comprises: searching for the search result corresponding to the search keyword, and resource and service information related to the content of the search result;
and displaying that search result comprising: displaying the search result, and resource and service information related to the content in the search result.

16. The terminal according to claim 10, wherein the step of matching the document title with the document content and the four types of keywords of model, commodity classification, brand, and market application extracted from the content to obtain a core keyword comprises:
matching the document title with the document content and four types of keyword of model, commodity classification, brand and market application extracted from the content, and combining the matched keyword into the core keyword according to the matching sequence of words in the document title.

17. The terminal according to claim 10, wherein after the matching of the document title with the document content and the four types of keywords of model, commodity classification, brand, and market application extracted from the content, the method further comprises:
if the document title is not matched with the document content, selecting a keyword extracted from the document content as the core keyword.

18. The terminal according to claim 10, wherein the displaying the search result comprises:
selecting part of the search result to display according to the page structure of the display page; and hiding and displaying the unselected search results as the information required by the search engine optimization.

19. The terminal according to claim 10, wherein the displaying the search result comprises:
selecting part of the search result to display according to the page structure of the display page; and hiding and displaying the unselected search results as the information required by the search engine optimization.

20. The terminal according to claim 10, wherein the searching a search result corresponding to the search keyword comprises: searching for the search result corresponding to the search keyword, and resource and service information related to the content of the search result;
and displaying that search result comprising: displaying the search result, and resource and service information related to the content in the search result.
